(19) United States
(12) Patent Application Publication
(10) Pub. No.: US 2018/0272612 A1
(43) Pub. Date: Sep. 27, 2018

(54) THREE-DIMENSIONAL SHAPE FORMING APPARATUS, INFORMATION PROCESSING APPARATUS, AND NON-TRANSITORY COMPUTER READABLE MEDIUM

(71) Applicant: FUJI XEROX CO., LTD., Tokyo (JP)

(72) Inventors: Kengo TOKUCHI, Kanagawa (JP); Motofumi BABA, Kanagawa (JP); Yoshihiko NEMOTO, Kanagawa (JP); Masahiro SATO, Kanagawa (JP); Akihito YAMAUCHI, Kanagawa (JP); Atsushi KAGAWA, Kanagawa (JP); Keita SAKAKURA, Kanagawa (JP)

(73) Assignee: FUJI XEROX CO., LTD., Tokyo (JP)

(21) Appl. No.: 15/699,371

(22) Filed: Sep. 8, 2017

(30) Foreign Application Priority Data
Mar. 24, 2017 (JP) 2017-059147

(51) Int. Cl. B29C 64/393; B33Y 50/02

(52) U.S. Cl. CPC B29C 64/393; G06F 3/147; B33Y 50/02

(57) ABSTRACT

A three-dimensional shape forming apparatus includes a forming unit and a controller. The forming unit forms a three-dimensional shape on the basis of three-dimensional data. The controller controls addition of a fragrance component to the three-dimensional shape in accordance with information regarding a fragrance when the three-dimensional data includes the information.

### CROSS-REFERENCE TO RELATED APPLICATIONS

This application is based on and claims priority under 35 USC 119 from Japanese Patent Application No. 2017-059147 filed Mar. 24, 2017.

### BACKGROUND

### (i) Technical Field

The present invention relates to a three-dimensional shape forming apparatus, an information processing apparatus, and a non-transitory computer readable medium.

### (ii) Related Art

Addition of new functions to a three-dimensional solid object (hereinafter referred to as a “three-dimensional shape”) forming apparatus has been currently sought. Additionally, further addition of functions to a three-dimensional shape formed by a three-dimensional shape forming apparatus has been sought.

### SUMMARY

According to an aspect of the invention, there is provided a three-dimensional shape forming apparatus including a forming unit and a controller. The forming unit forms a three-dimensional shape on the basis of three-dimensional data. The controller controls addition of a fragrance component to the three-dimensional shape in accordance with information regarding a fragrance when the three-dimensional data includes the information.

### BRIEF DESCRIPTION OF THE DRAWINGS

An exemplary embodiment of the present invention will be described in detail based on the following figures, wherein:

FIG. 1 is a diagram describing an exemplary connection configuration of an information processing apparatus and a three-dimensional shape forming apparatus according to an exemplary embodiment;

FIG. 2 is a diagram illustrating an exemplary hardware configuration of the information processing apparatus;

FIG. 3 is a diagram describing an exemplary functional configuration of a controller mounted in the information processing apparatus;

FIG. 4 is a diagram illustrating exemplary display of a fragrance reception screen;

FIG. 5 is a diagram illustrating an exemplary hardware configuration of the three-dimensional shape forming apparatus;

FIG. 6 is a diagram describing an exemplary functional configuration of a controller mounted in the three-dimensional shape forming apparatus;

FIG. 7 is a diagram describing an exemplary structure of a three-dimensional shape formed by the three-dimensional shape forming apparatus;

FIG. 8 is a diagram describing an example of an electronic circuit adopted in the case of causing a fragrance to arise by heating;

FIG. 9 is a diagram describing a first usage example of the three-dimensional shape;

FIGS. 10A and 10B are diagrams describing a second usage example of the three-dimensional shape;

FIGS. 11A and 11B are diagrams describing a third usage example of the three-dimensional shape;

FIGS. 12A and 12B are diagrams describing a fourth usage example of the three-dimensional shape;

FIGS. 13A and 13B are diagrams describing a fifth usage example of the three-dimensional shape; and

FIGS. 14A and 14B are diagrams describing a sixth usage example of the three-dimensional shape.

### DETAILED DESCRIPTION

Hereinafter, an exemplary embodiment of the present invention will be described in detail with reference to the attached drawings.

### Exemplary Embodiment

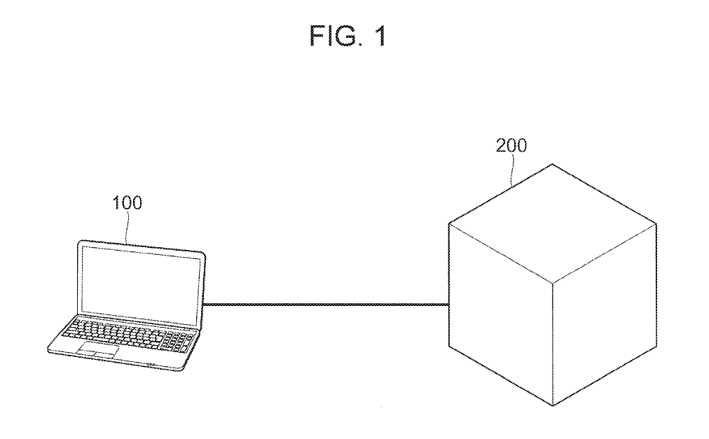

FIG. 1 is a diagram describing an exemplary connection configuration of an information processing apparatus 100 and a three-dimensional shape forming apparatus 200 according to an exemplary embodiment. It is only necessary for the information processing apparatus 100 and the three-dimensional shape forming apparatus 200 to be connected through a communication unit. Although the information processing apparatus 100 and the three-dimensional shape forming apparatus 200 are directly connected by a signal line in FIG. 1, the apparatuses 100 and 200 may alternatively be connected via a network.

The information processing apparatus 100 according to the exemplary embodiment is used as a three-dimensional solid object data (hereinafter referred to as “three-dimensional data”) generating apparatus. The information processing apparatus 100 is a so-called computer.

### Information Processing Apparatus

The information processing apparatus 100 will be described at first.

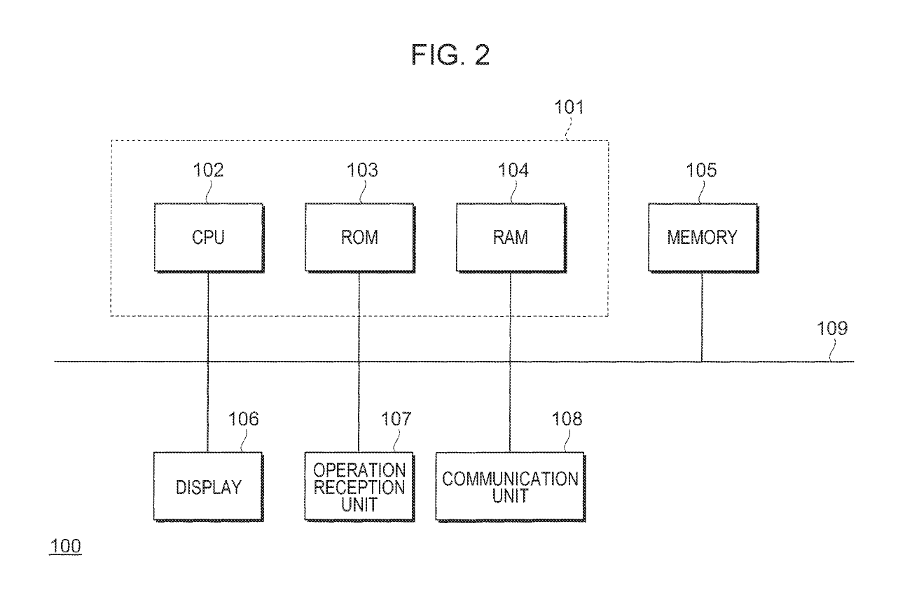

FIG. 2 is a diagram illustrating an exemplary hardware configuration of the information processing apparatus 100.

The information processing apparatus 100 includes a controller 101, which controls the entire apparatus, memory 105, which is used for storage of three-dimensional data and a program, a display 106, which is used for displaying images, an operation reception unit 107, which receives a user input operation, and a communication unit 108, which is used for communicating with an external apparatus (such as the three-dimensional shape forming apparatus 200).

These units are connected to one another through a bus 109 and exchange data through the bus 109.

The controller 101 is an example of a controller, and includes a central processing unit (CPU) 102, read-only memory (ROM) 103, and random-access memory (RAM) 104.

The ROM 103 stores a program to be executed by the CPU 102. The CPU 102 uses the RAM 104 as a work area and executes the program read from the ROM 103. The units of the information processing apparatus 100 are controlled through execution of the program.

The controller 101 according to the exemplary embodiment is an example of a reception unit and an example of a data generator.

The memory 105 includes a storage device such as a hard disk drive and semiconductor memory.

The display 106 is a display device that displays different images through execution of the program (including an operation system and firmware). The display 106 includes, for example, a liquid crystal panel or an organic electroluminescence (EL) display panel.

The operation reception unit 107 is an input device that receives an operation from a user, and includes, for example, a keyboard, one or more buttons, one or more switches, a touch pad, and a touchscreen.

The communication unit 108 includes, for example, a local area network (LAN) interface.

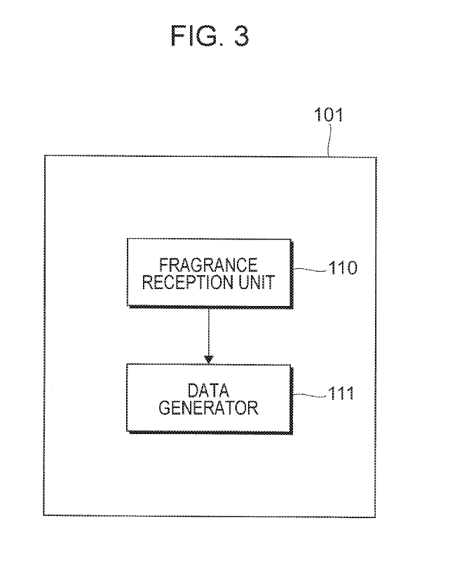

FIG. 3 is a diagram describing an exemplary functional configuration of the controller 101 mounted in the information processing apparatus 100. Functions of the controller 101 are realized through execution of the program.

The controller 101 according to the exemplary embodiment functions as a fragrance reception unit 110, which is used for specifying and inputting a portion to which a fragrance component is added, and a data generator 111, which generates three-dimensional data including information regarding a fragrance component.

The information regarding a fragrance component includes the name, system, region, and main component of a fragrance, which will be described later. The information regarding a fragrance component is an example of information regarding a fragrance.

The data generator 111 additionally has the function of, when a condition for a fragrance to arise is received by the fragrance reception unit 110, including, in three-dimensional data, the condition as part of the information regarding a fragrance component.

As the format of three-dimensional data, the stereolithography (SL) format representing a structure with polygon data, the fabricatable voxel (FAV) format representing a structure with voxel data, or the additive manufacturing file (AMF) format representing a structure with polygon data is used. Needless to say, these formats are only an example.

Existing formats are not prepared with a dedicated area for describing information regarding a fragrance component (hereinafter referred to as “fragrance data”). Therefore, these formats are extended when used in the exemplary embodiment.

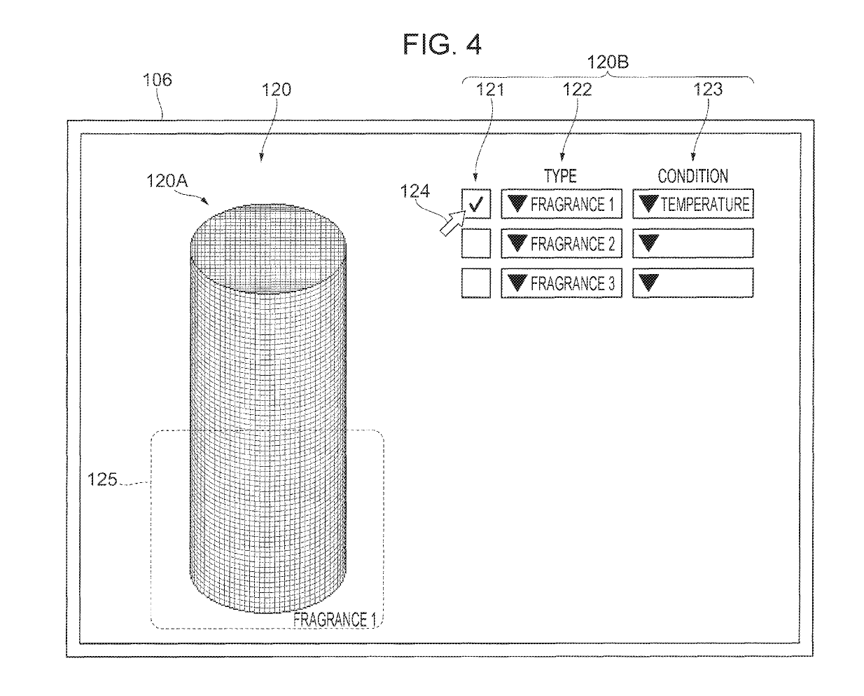

FIG. 4 is a diagram illustrating exemplary display of a fragrance reception screen 120 displayed on a display screen.

On the fragrance reception screen 120, a display field 120A displaying a three-dimensional shape to be formed, and an input field 120B for specifying a fragrance to be added to the three-dimensional shape are arranged. In the case of FIG. 4, a cylindrical column is displayed in the display field 120A. This three-dimensional shape may be colored or may not be colored.

Although an external figure which is the observation of the three-dimensional shape from an obliquely upward angle is displayed in the display field 120A in FIG. 4, the form of display is freely changeable in accordance with a user's selection. For example, the longitudinal section or cross-section of the three-dimensional shape may be displayed.

In the case of FIG. 4, the input field 120B includes a checkbox field 121 indicating a selected state, a type field 122 used for specifying the type of fragrance, and a condition field 123 used for specifying a condition for the fragrance to arise. In the case of FIG. 4, the input field 120B is capable of setting three types of fragrance. Needless to say, this display is only an example, and the number of input fields 120B may be one or two, or may be four or greater.

A pointer 124 is used for performing operation inputs on the fragrance reception screen 120. Besides being used for specifying a portion of the three-dimensional shape displayed in the display field 120A to which a fragrance is to be added, the pointer 124 is additionally used for entering instructions in the fields of the input field 120B.

FIG. 4 illustrates an example where a frame 125 is used for specifying a portion of the three-dimensional shape to which a fragrance is to be added.

FIG. 4 additionally displays that a fragrance applied to a portion of the three-dimensional shape surrounded by the frame 125 is “fragrance 1”. A check symbol indicating a selected state is displayed in the checkbox field 121 on the first line.

In the case of the exemplary embodiment, the fields of the type of fragrance and the fragrance arising condition are in the form of pull-down menus to select the respective items.

The type of fragrance is selectable from the viewpoints of name, system, region, and main component.

Exemplary names include the following: lavender, ylang-ylang, rose, chamomile, orange sweet, grapefruit, rosewood, cedarwood, bergamot, juniper, cypress, pelargonium, jasmine, lemon, peppermint, mandarin, marjoram, frankincense, rosemary, lemon grass, patchouli, sandalwood, thymus, and basil.

Exemplary systems include the following: floral, oriental, citrus, trees, herbs, spices, and resins.

Exemplary regions include the following: Southeast Asia, western, and middle east.

Exemplary main components include the following: lavender has linalool, linalyl acetate, β-ocimene, and terpinen-4-ol; and ylang-ylang has germacrene D, farnesene, β-caryophyllene, benzyl acetate, and benzyl benzoate.

The fragrance arising condition is provided to specify a condition for a fragrance component to exhibit volatility, and, for example, one of “temperature (air temperature)”, “humidity (moisture)”, and “heating” is selected.

It is known that a fragrance component generally becomes easily volatile when the temperature or humidity is high. Needless to say, the amount of volatilization in accordance with temperature or humidity is different depending on the type of fragrance component or solvent to be combined.

It is generally preferable that a fragrance component be added to a surface portion of a three-dimensional shape. In this way, the fragrance component may be easily emitted into the air. However, the fragrance component may be added to a deep portion instead of a surface portion such that the fragrance component will be emitted into the air only under a specific condition, for example. A deep portion means a portion that is deep in the thickness direction, and refers to an inner area at a predetermined depth or greater from the surface. A deep portion is, for example, an inner area at a depth of 1 mm or greater.

In the case where a condition for a fragrance component to exhibit volatility is not specifiable in terms of temperature or humidity, specification of the fragrance arising condition may be prohibited on the screen.

“Heating”, which is one of the fragrance arising conditions, is selected to control the arising of a fragrance component by heating with the use of a heat source embedded in the three-dimensional shape. This is used when changing a fragrance that arises from the three-dimensional shape in accordance with a specific temperature, humidity, time zone, place of use, region of use, the user's gender or age, or differences in type (such as different colors), on the assumption that a sensor or a switch will be used, and/or electronic data will be saved, for example.

When “heating” is selected, it is preferable that a fragrance component be added to the surroundings of a portion where a heat source is embedded. This is because it becomes easier to control emission of a fragrance component into the air by adding the fragrance component to a portion where heat propagates effectively.

When a heat source is used to cause a fragrance to arise, information regarding the arrangement position of the heat source may be included in part of metadata of three-dimensional data. If information regarding the arrangement position of the heat source is included in three-dimensional data, an area suitable for a fragrance component to be added may be suggested to the user on the screen of the fragrance reception screen 120.

When the three-dimensional shape forming apparatus 200 is capable of forming a heat source, an electrically conductive pattern, an electronic component, an integrated circuit, an antenna, or an electronic tag, information regarding materials and designs corresponding to these components is also included in three-dimensional data.

Three-dimensional data used in the exemplary embodiment assumes the FAV format. The FAV format is roughly divided into four parts. These four parts are metadata, palette, voxel, and object. Here, a voxel refers to a palette, and an object refers to a voxel.

Metadata includes metadata regarding different types of data defined in the FAV format.

In a palette, basic information, such as the shape and material of a voxel, is registered as a preparation for configuring three-dimensional data on the basis of the FAV format. An object is defined using a voxel configured by basic information registered in a palette.

A palette includes geometry and material, which are lower-hierarchical elements. In geometry, the definition of the shape and magnification of a voxel, which is a basic element of three-dimensional data, is described. The shapes to be defined include cube, plate, sphere, and cylindrical column. In material, material information to be set in a voxel, which is a basic element of three-dimensional data, is described.

A voxel contains information such as geometry and material registered in a palette. Therefore, it is possible for a voxel to define information other than the shape at each position of three-dimensional data.

A voxel includes geometry information (geometry_info), material information (material_info), display (display), and application note (application_note), which are lower-hierarchical elements.

Geometry information specifies the shape and magnification of a voxel. Material information sets material information. Display specifies color information. Color information is used to clearly visualize differences in properties, such as shape and material. An application note is used to store property information whose details to be described are unlimited.

An object includes a grid that provides a space for storing three-dimensional data, and a structure that defines the structure of three-dimensional data arranged in the grid.

A structure includes a voxel map (voxel_map), a color map (color_map), a link map (link_map), and a fragrance map (frag_map).

Here, a voxel map defines the presence of a voxel in each layer of an XY plane configuring a three-dimensional grid defined by a grid. A color map defines color information for the individual voxels listed in a voxel map. A link map represents the degree of bonding strength between voxels. A fragrance map defines a fragrance component to be added to each voxel. As a fragrance component here, information specified in the type field 122 of the fragrance reception screen 120 (FIG. 4) is described.

In the case of the exemplary embodiment, a fragrance map includes a condition, which is a lower-hierarchical element. In a condition, for example, information specified in the condition field 123 of the fragrance reception screen 120 (FIG. 4) is described.

A user may check the arrangement state of a material of the object described in units of voxels through a voxel-level enlarged view as illustrated in FIG. 4. That is, for each voxel, material information and fragrance information are described using information such as text and/or drawings, and a three-dimensional shape may be easily re-designed through the screen.

A fragrance component is generally disposed in a surface portion of a three-dimensional shape. This is because a fragrance added to a three-dimensional shape needs to be emitted into the air in order to reach the nasal cavities.

Therefore, the data generator 111 (see FIG. 3) additionally includes the function of, when a user gives an instruction to add a fragrance component, disposing the specified fragrance component in a surface portion of a three-dimensional shape to be formed.

Information regarding a fragrance component is not limited to a fragrance map or condition, and may be described in metadata.

As will be described later, there are various methods for forming a three-dimensional shape. Thus, in the information processing apparatus 100, part of three-dimensional data may be embedded with process information for adding a fragrance component according to forming method. That is, it is preferable for three-dimensional data to include multiple items of process information that are respectively associated with multiple forming methods.

When three-dimensional data includes multiple items of process information, the three-dimensional shape forming apparatus 200, which uses the three-dimensional data, is able to select process information in accordance with a usable forming method and to execute a process of forming a three-dimensional shape with a fragrance component.

When a forming method that is usable by the three-dimensional shape forming apparatus 200 becomes known before transmitting three-dimensional data through communication with the three-dimensional shape forming apparatus 200, only a forming process corresponding to the forming method of the three-dimensional shape forming apparatus 200, which is the transmission destination, may be included in three-dimensional data.

As has been described above, three-dimensional data where a fragrance component is associated with each voxel may be generated by using the information processing apparatus 100 according to the exemplary embodiment, and a three-dimensional shape as designed may be formed by giving the generated three-dimensional data to the three-dimensional shape forming apparatus 200.

If the strength of a three-dimensional shape to be formed becomes lower as a result of adding a fragrance component, the information processing apparatus 100 according to the exemplary embodiment may have the function of modifying the structure of the three-dimensional shape or a material for forming the three-dimensional shape in order to improve the strength, which will be described in more detail later. When the information processing apparatus 100 has this function, the operation of the three-dimensional shape forming apparatus 200 to modify the three-dimensional data may be omitted.

### Three-Dimensional Shape Forming Apparatus

Next, the three-dimensional shape forming apparatus 200 will be described.

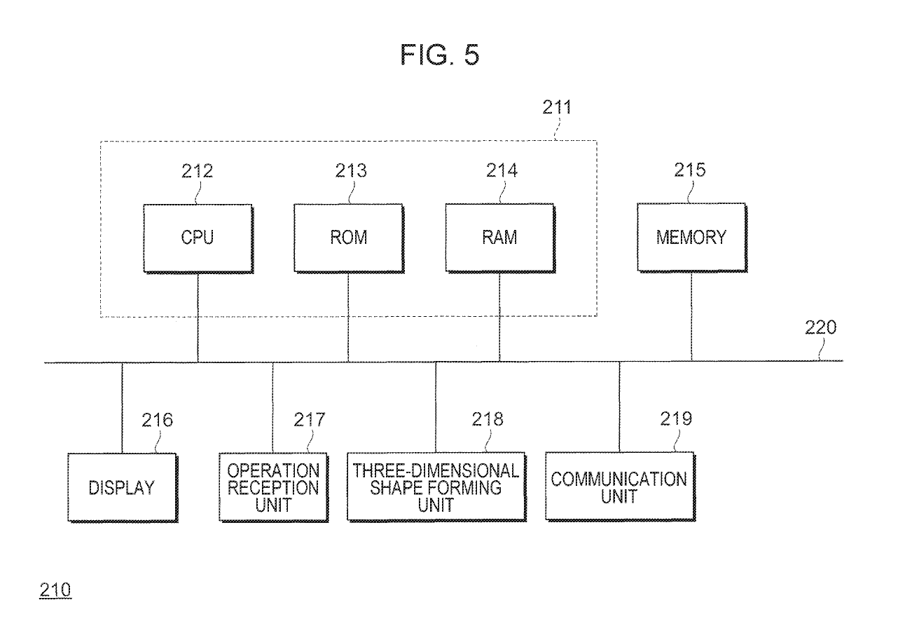

FIG. 5 is a diagram illustrating an exemplary hardware configuration of the three-dimensional shape forming apparatus 200.

The three-dimensional shape forming apparatus 200 includes a controller 211, which controls the entire apparatus, memory 215, which is used for storage of three-dimensional data and a program, a display 216, which is used for displaying an image corresponding to a to-be-formed three-dimensional shape, an operation reception unit 217, which receives a user input operation, a three-dimensional shape forming unit 218, which forms a three-dimensional shape on the basis of three-dimensional data, and a communication unit 219, which is used for communicating with an external apparatus (such as the information processing apparatus 100).

These units are connected to one another through a bus 220 and exchange data through the bus 220.

The controller 211 is an example of a controller, and includes a CPU 212, ROM 213, and RAM 214.

The ROM 213 stores a program to be executed by the CPU 212. The CPU 212 uses the RAM 214 as a work area and executes the program read from the ROM 213. The units of the three-dimensional shape forming apparatus 200 are controlled through execution of the program.

The memory 215 includes a storage device such as a hard disk drive and semiconductor memory, and is used for storage of three-dimensional data received from the information processing apparatus 100.

The display 216 is a display device that displays different images through execution of the program (including an operation system and firmware). The display 216 includes, for example, a liquid crystal panel or an organic EL display panel.

The operation reception unit 217 is an input device that receives an operation from a user, and includes, for example, a keyboard, one or more buttons, one or more switches, a touch pad, and a touchscreen.

As the three-dimensional shape forming unit 218, a device using a forming method suitable for the material and shape of a three-dimensional shape to be formed, specified by three-dimensional data, is used. The three-dimensional shape forming unit 218 is an example of a forming unit.

Exemplary forming methods include, for example, fused deposition modeling (FDM), stereolithography (SL), binder jetting, selective laser sintering (SLS), and inkjet.

When FDM (or material extrusion deposition) is adopted, the three-dimensional shape forming unit 218 forms a three-dimensional shape by extruding melted resin to form layers. Thermoplastic resin is used in this method.

When SL is adopted, the three-dimensional shape forming unit 218 forms a three-dimensional shape by photo-hardening photocurable resin in liquid form to form layers one by one with ultraviolet light lasers.

When binder jetting is adopted, the three-dimensional shape forming unit 218 forms a three-dimensional shape by injecting a water-soluble adhesive onto a powder bed (such as plaster) to solidify.

When SLS is adopted, the three-dimensional shape forming unit 218 forms a three-dimensional shape by scanning the surface of a powder material with lasers on the basis of cross-sectional data of a three-dimensional shape to harden.

When inkjet technology is adopted, the three-dimensional shape forming unit 218 forms a three-dimensional shape by hardening ultraviolet curable resin discharged from inkjet nozzles.

To form a three-dimensional shape using multiple materials, corresponding heads are prepared for the individual materials, and the heads are changed from one to another for each voxel.

When three-dimensional data includes a fragrance component, the three-dimensional shape forming unit 218 executes a process of adding a fragrance to a predetermined position during or after the process of forming a three-dimensional shape. The method of adding a fragrance component depends on the configuration of the three-dimensional shape forming apparatus 200 and materials usable by the three-dimensional shape forming apparatus 200.

For example, when a forming material mixed with a fragrance (contained in, for example, a micro-capsule with a size of a few microns to a few hundreds of microns) corresponding to a fragrance component specified by three-dimensional data is usable, a three-dimensional shape is formed using the forming material mixed with the fragrance.

Here, the micro-capsule containing the fragrance includes one or more cavities and is formed by a scientific method, a physicochemical method, a mechanical/physical method, or the like. Note that the particle diameter is only an example, and the particle diameter may be either an equivalent diameter or an effective diameter. It is only necessary that the average and distribution according to each measurement method be included within the above-described range.

A micro-capsule is suitable for storing a volatile fragrance for a long period of time. When a micro-capsule is destroyed by heat or friction, the contained fragrance is discharged into the air.

With the use of a micro-capsule that is destroyed at a specific temperature or humidity, a three-dimensional shape that discharges a specific fragrance component at a user's desired temperature or humidity may be formed.

The method of adding a fragrance component includes, for example, the method of filling or loading a space prepared in a three-dimensional shape with a fragrance, the method of applying a fragrance to a formed three-dimensional shape, and the method of moving a formed three-dimensional shape to a space for smoking and smoking the three-dimensional shape with a fragrance. A unit different from the three-dimensional shape forming unit 218 is used as necessary for adding a fragrance component.

As described above, three-dimensional data generated by the information processing apparatus 100 may include process information for adding a fragrance component to a three-dimensional shape for each of the multiple forming methods. In this case, the three-dimensional shape forming apparatus 200 reads process information that corresponds to a forming method of its own from the three-dimensional data, and executes a process of forming a three-dimensional shape.

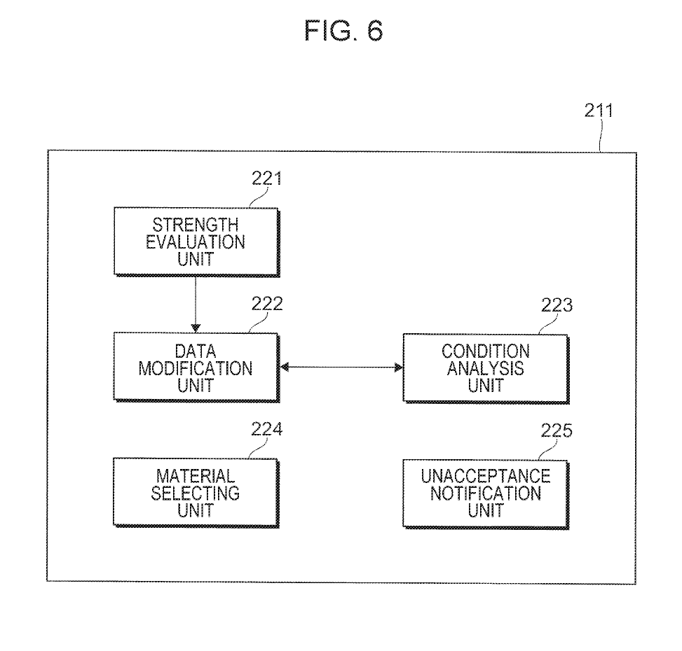

FIG. 6 is a diagram describing an exemplary functional configuration of the controller 211 mounted in the three-dimensional shape forming apparatus 200. Functions of the controller 211 are realized through execution of the program.

The controller 211 according to the exemplary embodiment functions as a strength evaluation unit 221, which evaluates the strength of a three-dimensional shape formed on the basis of the received three-dimensional data, and a data modification unit 222, which modifies a material or structure specified by the three-dimensional data when the designed strength is not achieved.

The strength evaluation unit 221 is a function unit that executes a structure simulation to evaluate whether a three-dimensional shape formed on the basis of three-dimensional data exhibits a predetermined strength. For example, the conceivable case is that the strength decreases when a space such as a gap is disposed in a three-dimensional shape for filling or loading the space with a fragrance, or that the strength decreases when the thickness of a structure is decreased by disposing a voxel mixed with a fragrance at a surface portion.

When the result of the structure simulation indicates that there is a portion that lacks strength, the strength evaluation unit 221 gives information regarding this portion to the data modification unit 222.

The data modification unit 222 is a function unit that, upon detection of a lack of strength, changes the material or modifies the internal structure. The data modification unit 222 executes, for example, a change to a material for forming a portion where a lack of strength has been detected or its surrounding portion (including replacement of the material and addition of a reinforcing material), or additive disposition of a structure into an internal space of the three-dimensional shape. The modification here includes addition of a protective layer through which a fragrance component may pass to the surface of a portion where a fragrance component has been added.

The controller 211 according to the exemplary embodiment additionally functions as a condition analysis unit 223, which analyzes a condition for a fragrance component to arise, which is included in three-dimensional data, a material selecting unit 224, which selects a specific material in accordance with the fragrance arising condition, and an unacceptance notification unit 225, which notifies the user of the fact that a three-dimensional shape as specified by the three-dimensional data is not formable, before formation of the three-dimensional shape starts.

The condition analysis unit 223 provides, when a portion to which a fragrance component is to be added (the position of a voxel to which a fragrance component is to be added) has not been specified in three-dimensional data, the function of giving a position suitable for adding a fragrance component to the data modification unit 222. The data modification unit 222 is given, for example, disposition of a fragrance component to a surface portion of a three-dimensional shape, or disposition of a fragrance component to a portion whose heat propagation distance from a heat source is short. In this case, the data modification unit 222 executes a process of adding, to the three-dimensional data, a portion to which a fragrance component is to be added. For example, when moisture is specified as the fragrance arising condition, the data modification unit 222 modifies the three-dimensional data such that a fragrance component will be disposed in a surface portion of the three-dimensional shape.

The material selecting unit 224 executes a process of selecting a fragrance that gives rise to a fragrance whose name has been specified by three-dimensional data, or selecting a fragrance contained in a micro-capsule that is suited for a fragrance arising condition specified by three-dimensional data. The material selecting unit 224 reads, from the memory 215, information regarding a fragrance and material that are usable by the three-dimensional shape forming unit 218, and determines a specific material. The material selecting unit 224 may communicate with an external server or the like through the communication unit 219 to obtain information on a replacement material.

The unacceptance notification unit 225 provides the function of, when it is difficult to form a three-dimensional shape using a fragrance and another material that are finally determined (including a lack of material), notifying the user thereof. The user may be notified using the display 216 or by turning on a warning lamp (not illustrated), or the information processing apparatus 100, which is the transmission source of three-dimensional data, may be notified through the communication unit 219. With this notification function, an unnecessary forming operation may be avoided in advance, and a waste of material may be reduced.

As has been described above, a three-dimensional shape with a fragrance may be formed using the three-dimensional shape forming apparatus 200 according to the exemplary embodiment.

When a lack of strength occurs as a result of adding a fragrance, the three-dimensional data may be modified to increase the strength by using the three-dimensional shape forming apparatus 200 according to the exemplary embodiment.

Even when a fragrance material in accordance with the fragrance arising condition has not been specified, a fragrance material that satisfies the fragrance arising condition may be selected using the three-dimensional shape forming apparatus 200 according to the exemplary embodiment.

Even when a position to which a fragrance component is to be added is not specifically specified in the three-dimensional data, a fragrance component may be added to a portion in accordance with the fragrance arising condition by using the three-dimensional shape forming apparatus 200 according to the exemplary embodiment.

When a three-dimensional shape to which an intended fragrance component is added may not be formed, the user may be notified thereof in advance by using the three-dimensional shape forming apparatus 200 according to the exemplary embodiment, thereby reducing a waste of material.

### Exemplary Structure of Three-Dimensional Shape

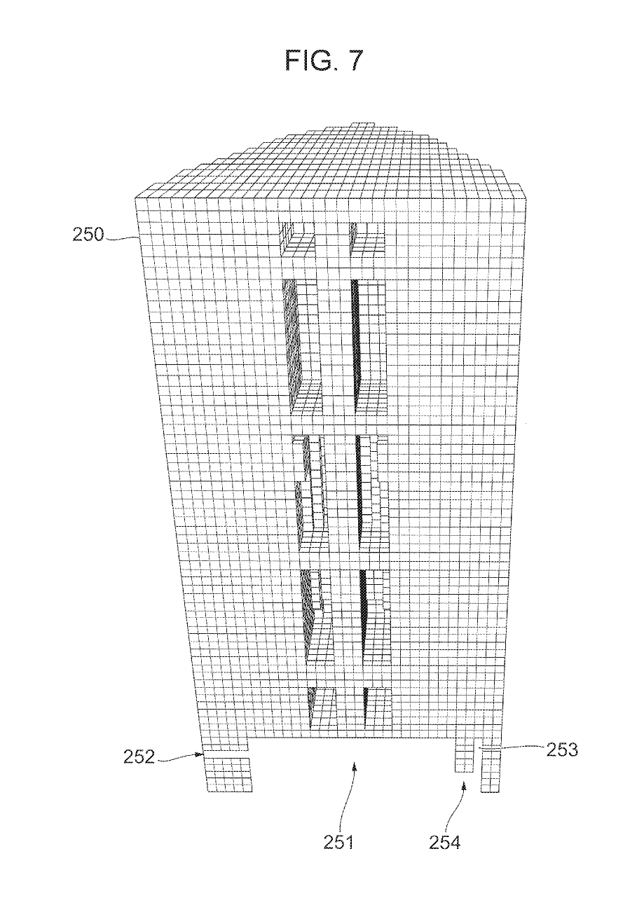

FIG. 7 is a diagram describing an exemplary structure of a three-dimensional shape 250 formed by the three-dimensional shape forming apparatus 200. FIG. 7 illustrates a cross-sectional structure, cut in the longitudinal direction, of the three-dimensional shape 250. The three-dimensional shape 250 corresponds to a cylindrical column.

In the case of the three-dimensional shape 250 illustrated in FIG. 7, a cavity 251 is formed on the bottom side, which contains a battery and a switch SW. A through-hole 252, which reaches the outer surface of the three-dimensional shape 250, is formed on the lateral side of the cavity 251. The through-hole 252 is used for attaching and wiring various sensors in accordance with the form of use.

Needless to say, when sensors and wiring may be formed of metals, sensors and wiring are formed in the portion of the through-hole 252.

A gap 253 is formed between the cavity 251 and the outer surface of the three-dimensional shape 250 for attaching a heating element from the bottom side. The gap 253 is provided to decrease the distance between the heating element and the fragrance while maintaining the strength of the three-dimensional shape 250. The cavity 251 and the gap 253 are connected by a coupling path 254 for wiring.

When the heating element and wiring may be formed of metals, portions such as the gap 253 and the coupling path 254 are formed of metals.

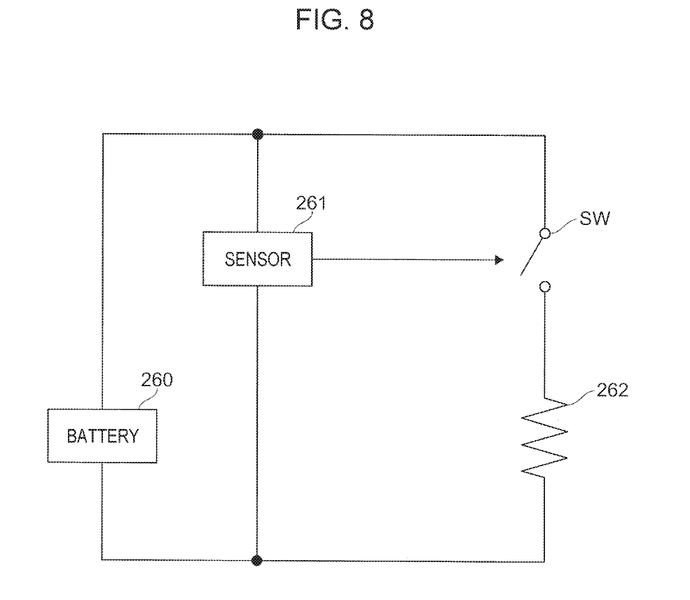

FIG. 8 is a diagram describing an example of an electronic circuit adopted in the case of causing a fragrance to arise by heating.

In the case of FIG. 8, the electronic circuit controls turning ON/OFF of the switch SW connected in series with the heating element 262 in accordance with the output of a sensor 261, which receives electric power from the battery 260 and operates, thereby controlling current application to the heating element 262 (that is, heating).

Needless to say, when heating is not adopted to cause a fragrance to arise (that is, when friction against the three-dimensional shape 250 or the temperature (air temperature) or humidity (moisture) in the usage environment is used), the mechanisms illustrated in FIGS. 7 and 8 are unnecessary.

Although the battery 260 is used as a power source in the exemplary embodiment, power may be supplied wirelessly from the outside. In this case, an antenna serving as a power reception unit may be formed of metals.

### USAGE EXAMPLES

Next, usage examples of the formed three-dimensional shape will be described.

### First Usage Example

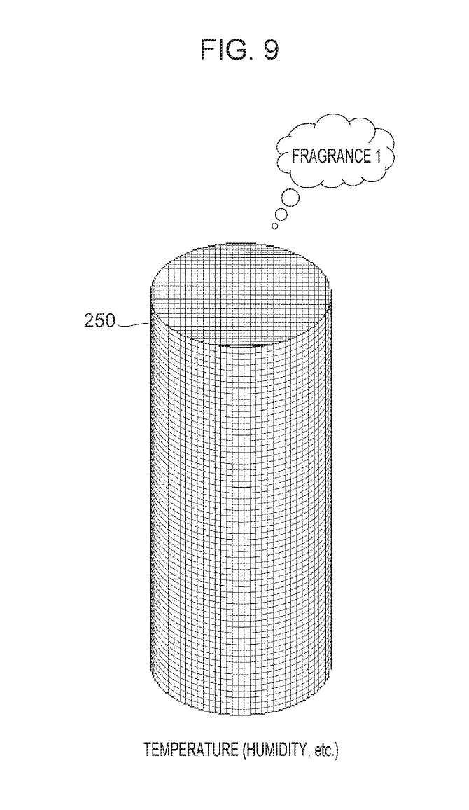

FIG. 9 is a diagram describing a first usage example of the three-dimensional shape 250. The first usage example is the case where one type of fragrance component is added to the three-dimensional shape 250. In this case, a specific fragrance (fragrance 1) arises when the temperature and/or humidity satisfy specific conditions.

The fragrance may arise by heating or in accordance with the usage environment.

When heating is adopted, for example, the fragrance may arise in a specific time zone (such as 7 o'clock in the morning) by controlling ON/OFF the switch SW on the basis of a timer or time data.

When the fragrance arises in accordance with the usage environment (in other words, passively or depending on the characteristics of the micro-capsule), the fragrance may arise in response to an increase in the outdoor temperature at a place where the three-dimensional shape 250 is used, or an increase in temperature in response to a person's holding or rubbing against the three-dimensional shape 250. The fragrance may arise by destroying the micro-capsule when the micro-capsule comes into contact with rainwater.

### Second Usage Example

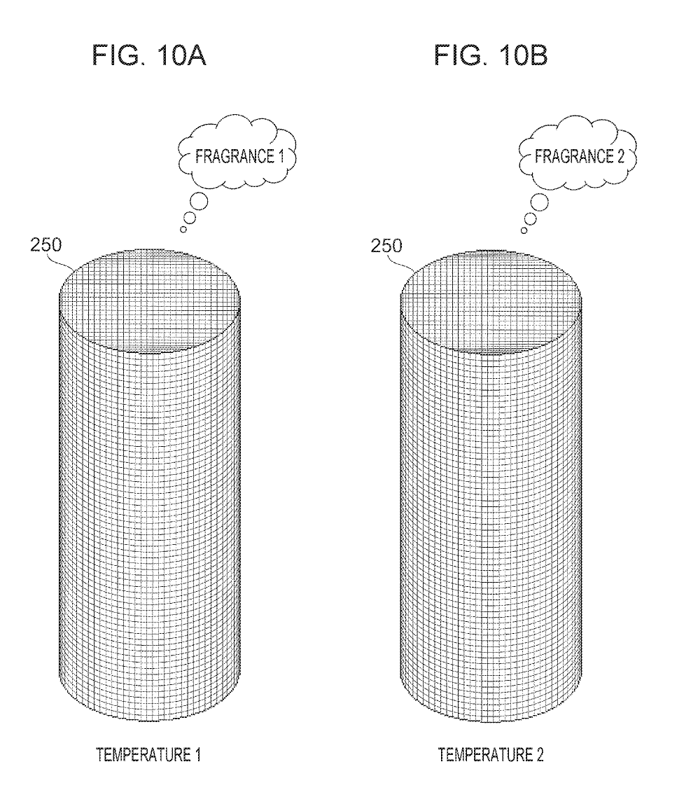

FIGS. 10A and 10B are diagrams describing a second usage example of the three-dimensional shape 250. The second usage example is the case where two types of fragrance components are added to the three-dimensional shape 250. In FIGS. 10A and 10B, different fragrances arise at different temperatures.

To cause a fragrance to arise in accordance with the usage environment, a material is selected such that a temperature at which a micro-capsule containing a fragrance corresponding to a fragrance 1 is destroyed and a temperature at which a micro-capsule containing a fragrance corresponding to a fragrance 2 is destroyed do not overlap. In this case, the fragrance 1 arises at a temperature 1, and the fragrance 2 arises at a temperature 2.

In contrast, when heating is adopted, at least two heating elements 262 are arranged at a distance in the three-dimensional shape 250, and heating by the two heating elements 262 is selectively executed in accordance with the output of a temperature sensor. In this case, it is preferable to arrange the two heating elements 262 such that their heating do not influence each other, or to adopt a structure (such as a slit) that cuts off heat conduction.

### Third Usage Example

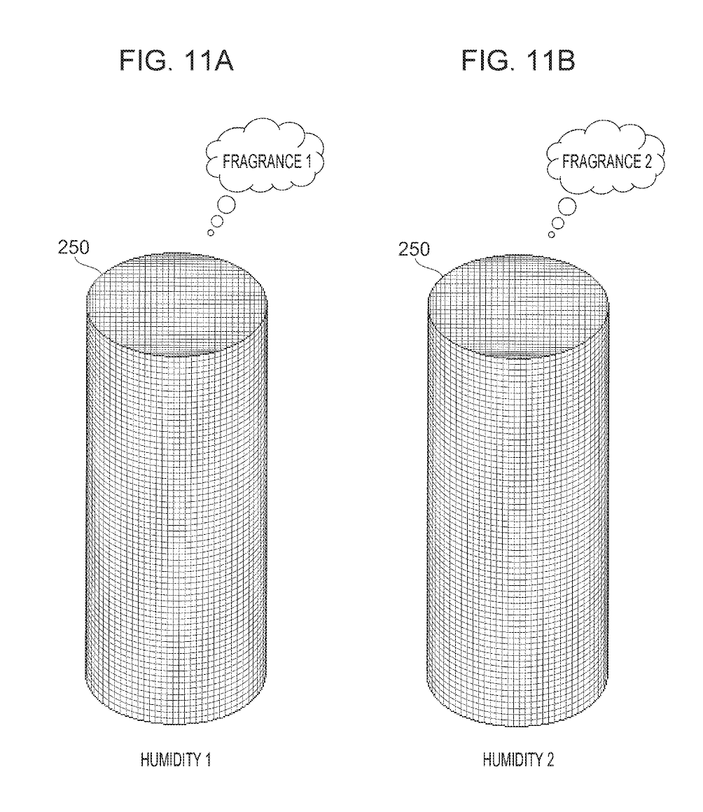

FIGS. 11A and 11B are diagrams describing a third usage example of the three-dimensional shape 250. The third usage example is the case where two types of fragrance components are added to the three-dimensional shape 250. In FIGS. 11A and 11B, different fragrances arise at different humidities.

To cause a fragrance to arise in accordance with the usage environment, a material is selected such that a humidity at which a micro-capsule containing a fragrance corresponding to a fragrance 1 is destroyed and a humidity at which a micro-capsule containing a fragrance corresponding to a fragrance 2 is destroyed do not overlap. In this case, the fragrance 1 arises at a humidity 1, and the fragrance 2 arises at a humidity 2.

In contrast, when heating is adopted, at least two heating elements 262 are arranged at a distance in the three-dimensional shape 250, and heating by the two heating elements 262 is selectively executed in accordance with the output of a humidity sensor. In this case, it is preferable to arrange the two heating elements 262 such that their heating do not influence each other, or to adopt a structure (such as a slit) that cuts off heat conduction.

### Fourth Usage Example

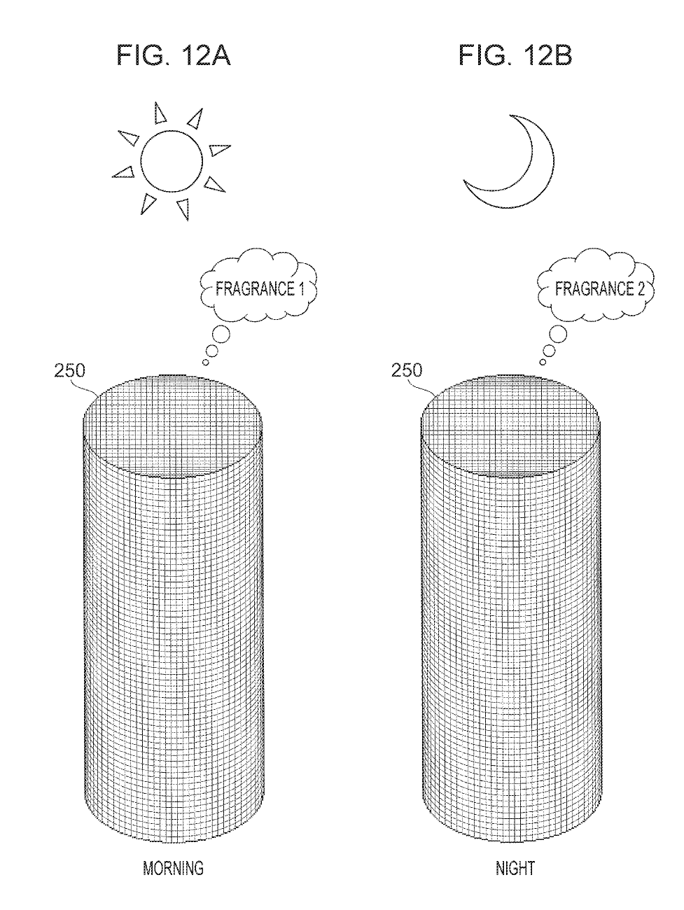

FIGS. 12A and 12B are diagrams describing a fourth usage example of the three-dimensional shape 250. The fourth usage example is the case where two types of fragrance components are added to the three-dimensional shape 250. In FIGS. 12A and 12B, different fragrances arise by time zone.

Heating is adopted in the case of the fourth usage example. In this usage example, a timer or a clock is disposed in the three-dimensional shape 250, and heating by the two heating elements 262 is selectively executed using the output of the timer or clock. For example, a fresh mint fragrance (fragrance 1) may arise in the morning, and a lavender fragrance expected to have relaxing effects may arise at night. Also in this case, it is preferable to arrange the two heating elements 262 such that their heating do not influence each other, or to adopt a structure (such as a slit) that cuts off heat conduction.

### Fifth Usage Example

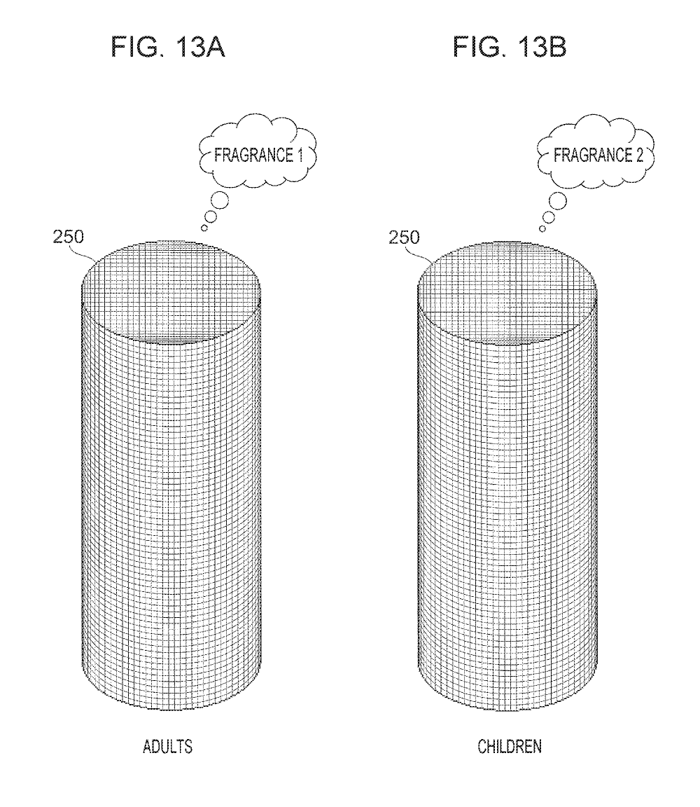

FIGS. 13A and 13B are diagrams describing a fifth usage example of the three-dimensional shape 250. The fifth usage example is the case where two types of fragrance components are added to the three-dimensional shape 250. In FIGS. 13A and 13B, different fragrances arise by the user's age.

Heating is adopted in the case of the fifth usage example. In this usage example, a switch is disposed in the three-dimensional shape 250, and heating by the two heating elements 262 is selectively executed by switching the switch. For example, a rose fragrance (fragrance 1) may arise for adults, and an orange fragrance (fragrance 2) may arise for children. Also in this case, it is preferable to arrange the two heating elements 262 such that their heating do not influence each other, or to adopt a structure (such as a slit) that cuts off heat conduction.

The fifth usage example may be used when changing the fragrance by the user's gender.

### Sixth Usage Example

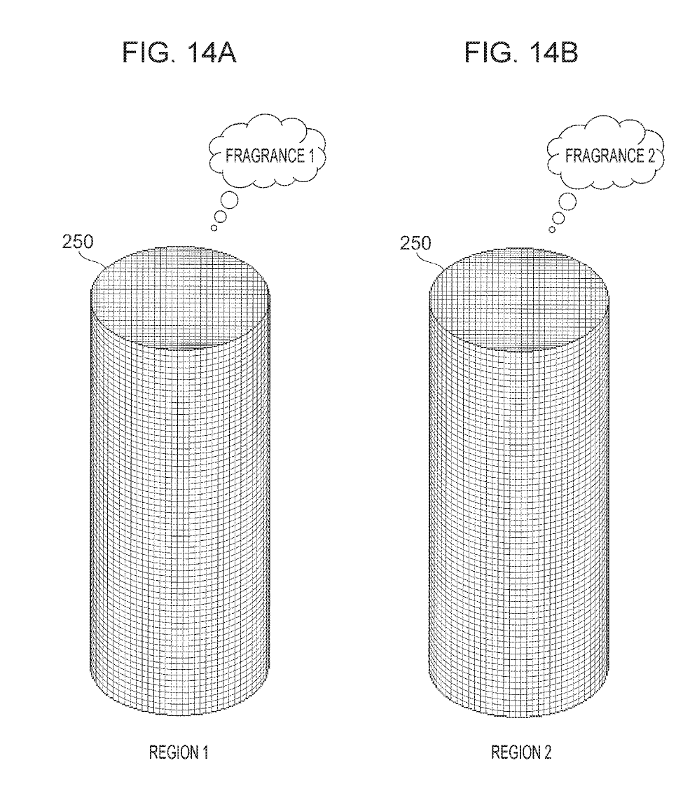

FIGS. 14A and 14B are diagrams describing a sixth usage example of the three-dimensional shape 250. The sixth usage example is the case where two types of fragrance components are added to the three-dimensional shape 250. In FIGS. 14A and 14B, different fragrances arise by the region of use.

Heating is adopted in the case of the sixth usage example. In this usage example, a switch is disposed in the three-dimensional shape 250, and heating by the two heating elements 262 is selectively executed by switching the switch. For example, a lemon grass fragrance (fragrance 1) arises in Southeast Asia (region 1), and a rosemary fragrance (fragrance 2) may arise in Europe (region 2). Also in this case, it is preferable to arrange the two heating elements 262 such that their heating do not influence each other, or to adopt a structure (such as a slit) that cuts off heat conduction.

### Other Exemplary Embodiments

Although the exemplary embodiment of the present invention has been described as above, the technical scope of the present invention is not limited to the range described in the exemplary embodiment. It is clear from the scope of claims that various changes or modifications added to the exemplary embodiment are also included in the technical scope of the present invention.

For example, although the FAV format is used as an exemplary format of three-dimensional data in the above-described exemplary embodiment, fragrance data may be added to the SL format or the AMF format adopting a polygon mesh structure configured of faces and vertices and may be used. One or more objects configuring a polygon mesh structure is described by one or more volumes whose spaces do not overlap each other. A volume is an element that connects a list of vertices and the vertices.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimensional shape forming apparatus comprising:
a forming unit that forms a three-dimensional shape on a basis of three-dimensional data; and
a controller that controls addition of a fragrance component to the three-dimensional shape in accordance with information regarding a fragrance when the three-dimensional data includes the information.

2. The three-dimensional shape forming apparatus according to claim 1, wherein, to add the fragrance component, the controller adds a structure that increases strength of one or both of a portion to which the fragrance component is added and a surrounding portion.

3. The three-dimensional shape forming apparatus according to claim 2, wherein the controller adds a structure.

4. The three-dimensional shape forming apparatus according to claim 2, wherein the controller adds a protective layer to a surface of the portion to which the fragrance component is added.

5. The three-dimensional shape forming apparatus according to claim 1, wherein the controller selects a fragrance material in accordance with a condition for causing the fragrance component to arise when the three-dimensional data includes the condition.

6. The three-dimensional shape forming apparatus according to claim 5, wherein the controller adds the fragrance component to a surface portion of the three-dimensional shape when moisture is specified as the condition.

7. The three-dimensional shape forming apparatus according to claim 5, wherein the controller adds the fragrance component to a portion to which heat from a heat source propagates when heating is specified as the condition.

8. The three-dimensional shape forming apparatus according to claim 7, wherein the heat source is one of a plurality of heat sources, and the fragrance component is one of different fragrance components, and wherein the different fragrance components are added for the plurality of heat sources.

9. The three-dimensional shape forming apparatus according to claim 1, wherein, when addition of the fragrance component in accordance with the information regarding a fragrance is not possible, a notification indicating thereof is given before formation of the three-dimensional shape starts.

10. An information processing apparatus comprising:
a reception unit that receives a portion to which information regarding a fragrance is added, on a screen displaying a three-dimensional shape to be formed; and
a data generator that generates three-dimensional data including the information regarding a fragrance.

11. The information processing apparatus according to claim 10, wherein the data generator includes, in the three-dimensional data, a condition for causing a fragrance to arise, the condition being received through the reception unit.

12. A non-transitory computer readable medium storing a program causing a computer to execute a process, the process comprising:
receiving a portion to which information regarding a fragrance is added, on a screen displaying a three-dimensional shape to be formed; and
generating three-dimensional data including the information regarding a fragrance.
